(19) United States
(12) Patent Application Publication
(10) Pub. No.: US 2025/0062883 A1
(43) Pub. Date: Feb. 20, 2025

(54) WIRELESS COMMUNICATION SYSTEM AND METHOD FOR PROCESSING PHYSICAL RESOURCE BLOCKS

(71) Applicant: HFR, INC., Seongnam-si (KR)

(72) Inventors: Jai Seo PARK, Seongnam-si (KR); Hee Sung SHIN, Suwon-si (KR); Kyong Mo MIN, Seongnam-si (KR)

(73) Assignee: HFR, INC., Seongnam-si (KR)

(21) Appl. No.: 18/939,847

(22) Filed: Nov. 7, 2024

Related U.S. Application Data
(63) Continuation of application No. PCT/KR2023/012149, filed on Aug. 17, 2023.

(30) Foreign Application Priority Data
Dec. 16, 2022 (KR) 10-2022-0176619

(51) Int. Cl. H04L 5/00; H04W 72/04

(52) U.S. Cl. CPC H04L 5/0094; H04W 72/04

(57) ABSTRACT

Provided is a method for processing a physical resource block in a wireless communication system. The method includes identifying, by a distributed unit, user equipment (UE) connected to each of a plurality of radio units (RUs) and acquiring connection information, generating, by the distributed unit, physical resource block allocation information on a resource block area allocated to each of the plurality of RUs based on the connection information, distributing, by a fronthaul multiplexer (FHM), the resource block area allocated to each of the plurality of RUs based on the physical resource block allocation information, and transmitting, by each of the plurality of RUs, a radio signal to at least one UE based on the distributed physical resource block area.

### CROSS-REFERENCE TO RELATED PATENT APPLICATION

This application is a Continuation of International Application No. PCT/KR2023/012149 filed Aug. 17, 2023, which claims benefit of priority to Korean Patent Application No. 10-2022-0176619 filed Dec. 16, 2023 in the Korean Intellectual Property Office, the disclosure of which is incorporated herein in its entirety by reference.

### TECHNICAL FIELD

The present invention relates to a device and method for processing a physical resource block in a communication system, and more particularly, to a technology for processing a physical resource block (PRB) in a fronthaul multiplexer (FHM).

### BACKGROUND ART

Along with the development of information and communication technology, various wireless communication technologies are being developed. Representative wireless communication technologies include long term evolution (LTE) and new radio (NR), which are defined in the 3rd generation partnership project (3GPP) standard. The LTE can be one wireless communication technology among the 4th generation (4G) wireless communication technologies, and the NR can be one wireless communication technology among the 5th generation (5G) wireless communication technologies.

Meanwhile, as wireless communication technology develops, the frequency of use increases and the bandwidth becomes larger. The higher the frequency, the lower the diffraction of radio waves and the stronger their linear propagation, which significantly reduces radio wave's reach distance. Therefore, in densely populated urban areas, as the communication technology evolves from LTE to NR, more base stations must be installed densely.

In addition, as the radio access network (RAN) technology develops, radio access processing demands increases due to the increase in wireless communication speed and the adoption of multiple-input multiple-output (MIMO), and the cost of installing mobile communication base stations increases. To address this issue, the structure of RAN was divided into a central unit (CU), a distributed unit (DU), and a radio unit (RU). Each of these divided units is supplied by various manufacturers, and an open radio access network (O-RAN) interface, which is a packet-based communication, is applied to ensure compatibility between the units.

In addition, as one of methods to reduce the cost of building the RAN, a plurality of radio units is used in the same cell through a shared cell function to cost-effectively expand service coverage.

However, there is a problem that the overall power consumption of the RAN further increases due to the increase in the number of used radio units due to the coverage expansion. In addition, regardless of user equipment (UE) within the coverage served by the radio unit, there is a problem that all the radio units consume the maximum power consumption by transmitting a physical resource block of the entire cell of a base station equally to all radio units.

For example, in a case where there are a plurality of radio units in one cell of a base station, even when there is UE only in a first radio unit and there is no UE in the remaining second radio unit, all the radio units may transmit electromagnetic waves of the same intensity instead of only the first radio unit transmitting waves. Therefore, all the radio units, including radio units that do not have data access, transmit electromagnetic waves of maximum power, causing a problem in that the total power consumption of a distributed network increases rapidly.

Therefore, there is a need for a technology for reducing the power consumption of radio units, which account for a significant portion of overall power usage.

Meanwhile, the background technology described above is not necessarily a publicly known technology disclosed to the general public before the filing of the present invention.

### RELATED ART DOCUMENTS

[Patent Document 1] Korean Patent Publication No. 10-2014-0103496 (Aug. 27, 2014)

### DISCLOSURE

### Technical Problem

The present invention is directed to providing a fronthaul multiplexer (FHM) that may distribute, when there are a plurality of radio units (RUs) in one cell of a base station in a distributed network structure, a physical resource block to each of the plurality of O-RUs so that each of the O-RUs can transmit radio signals only for user equipment (UE) connected to each of the O-RUs, thereby reducing power consumed by the O-RUs.

The present invention is also directed to providing a FHM that can transmit only packet data for a physical resource block allocated to each RU to each RU based on information on the physical resource block allocated by scheduling between UE and a base station within a service coverage of each RU, thereby reducing power consumed by the O-RUs.

The technical problems of the present invention are not limited to the problems mentioned above, and other problems not explicitly mentioned will be apparent to those skilled in the art from the following description.

### Technical Solution

One aspect of the present invention provides a method for processing a physical resource block in a wireless communication system, which may include identifying, by a distributed unit, user equipment (UE) connected to each of a plurality of radio units (RUs) and acquiring connection information, generating, by the distributed unit, physical resource block allocation information on a resource block area allocated to each of the plurality of RUs based on the connection information, distributing, by a fronthaul multiplexer (FHM), the resource block area allocated to each of the plurality of RUs based on the physical resource block allocation information, and transmitting, by each of the plurality of RUs, a radio signal to at least one piece of UE based on the distributed physical resource block area.

According to another embodiment of the present invention, the acquiring of the connection information may include transmitting, by the distributed unit, a mapping table related to a beam ID and a section ID to the FHM by performing a management plane start-up procedure.

According to another embodiment of the present invention, the acquiring of the connection information may include transmitting, by the distributed unit, a user plane (U-plane) message including a UE synchronization control signal to the FHM, and transmitting, by the distributed unit, a control plane (C-plane) message including a beam ID and a section ID to the FHM.

According to another embodiment of the present invention, the UE synchronization control signal may include a synchronization signal block or a channel state information-reference signal (CSI-RS).

According to another embodiment of the present invention, the control plane message may include a physical random access channel (PRACH) corresponding to the UE synchronization control signal.

According to another embodiment of the present invention, the acquiring of the connection information may include acquiring, by the FHM, the beam ID and the section ID based on header information of the received control plane message, selecting, by the FHM, a RU to be routed among the plurality of RUs based on the acquired beam ID and section ID, and transmitting, by the FHM, the user plane message and the control plane message corresponding to the selected RU to the selected RU.

According to another embodiment of the present invention, the acquiring of the connection information may include transmitting, by the selected RU, the UE synchronization control signal to at least one piece of UE, receiving, by the selected RU, a PRACH preamble corresponding to the UE synchronization control signal from the UE, transmitting, by the selected RU, the received PRACH preamble to the FHM, and transmitting, by the FHM, the received PRACH preamble to the distributed unit.

According to another embodiment of the present invention, the generating of the physical resource block allocation information may include generating the physical resource block allocation information by matching a section ID and a beam ID for a resource block area used by each of the plurality of RUs.

According to another embodiment of the present invention, the distributing of the physical resource block may include selecting, by the FHM, one RU to be routed from the plurality of RUs based on the beam ID and the section ID, and transmitting a user plane message and a control plane message corresponding to the selected RU to the selected RU.

According to another embodiment of the present invention, the transmitting of the radio signal may include transmitting a radio signal for the physical resource block allocated to the selected RU.

### Advantageous Effects

According to embodiments of the present invention, when there are a plurality of radio units (RUs) in one cell of a base station in a distributed network structure, a fronthaul multiplexer (FHM) can distribute a physical resource block to each of the plurality of RUs so that each of the plurality of RUs transmits a radio signal wave only for UE connected to each of the plurality of RUs, thereby reducing the power consumed by the RUs.

Also, according to embodiments of the present invention, a FHM that can transmit only packet data for a physical resource block allocated to each RU to each RU based on physical resource block allocation information for a physical resource block allocated by scheduling between UE and a base station within a service coverage of each RU, thereby reducing the power consumed by the RUs.

The effects obtainable from the present invention are not limited to the effects mentioned above, and other effects not mentioned will be clearly understood by a person skilled in the art to which the present invention belongs from the description below.

### DESCRIPTION OF DRAWINGS

FIG. 1 is a diagram illustrating a schematic configuration of a wireless communication system according to an embodiment of the present invention.

FIG. 2 is a diagram illustrating a base station according to an embodiment of the present invention.

FIG. 3 is a diagram illustrating a network configuration including a fronthaul multiplexer (FHM) according to an embodiment of the present invention.

FIG. 4 is a block diagram illustrating a radio unit according to an embodiment of the present invention.

FIG. 5 is a block diagram illustrating a distributed unit according to an embodiment of the present invention.

FIG. 6 is a block diagram illustrating a central unit according to an embodiment of the present invention.

FIG. 7 is a block diagram illustrating a FHM according to an embodiment of the present invention.

FIG. 8 is a block diagram illustrating user equipment (UE) according to an embodiment of the present invention.

FIG. 9 is a diagram illustrating a method for processing a physical resource block in a conventional wireless communication system.

FIG. 10 is a diagram illustrating a method for processing a physical resource block in a wireless communication system according to an embodiment of the present invention.

FIG. 11 is a flowchart illustrating a method for processing a physical resource block in a wireless communication system according to an embodiment of the present invention.

FIG. 12 is a flowchart illustrating a method for processing a physical resource block in a wireless communication system according to an embodiment of the present invention.

FIG. 13 is a flowchart illustrating a method for processing a physical resource block in a wireless communication system according to an embodiment of the present invention.

FIG. 14 is a flowchart illustrating a method for selecting a radio unit to be routed according to an embodiment of the present invention.

### MODES OF THE INVENTION

Advantages and technical features of the present disclosure, and methods for achieving the advantages and the technical features will be clarified with reference to embodiments described below in detail together with the accompanying drawings. However, the present disclosure is not limited to the embodiments disclosed below, but will be implemented in various different forms. The embodiments allow the disclosure of the present disclosure to be complete and the ordinary skilled in the art to fully understand. The present disclosure is only defined by the scope of the claims.

The shapes, sizes, ratios, angles, numbers, etc., disclosed in the drawings for describing the embodiments of the present invention are exemplary, and the present invention is not limited to the drawings. In addition, in the description of the present disclosure, when it is determined that detailed descriptions of related known technologies may unnecessarily obscure the subject matter of the present disclosure, detailed descriptions thereof will be omitted. When “include,” “have,” “consist of,” etc., are used in this specification, other parts may be added unless “only” is used. When a component is expressed as a singular number, the plural number is included unless otherwise specified.

In interpreting the components, it is interpreted as including the error range even if there is no explicit description.

Terms “first,” “second,” etc., are used to describe various components, but these components are not limited by these terms. These terms are only used to distinguish one component from another component. Accordingly, the first component mentioned below may be the second component within the technical spirit of the present disclosure.

Unless otherwise specified, the same reference numerals throughout the specification refer to the same components

Each of the specific embodiments of the present invention can be partially or entirely combined or combined with each other, and as can be fully understood by those skilled in the art, various technical connections and operations are possible, and each embodiment can be implemented independently of each other or can be implemented together in a related relationship.

Meanwhile, the tentative effects that can be expected by the technical specifics of the present invention that are not specifically mentioned in the specification of the present invention are treated as described in the specification, and this embodiment is provided to more completely explain the present invention to a person having average knowledge in the art, and the contents depicted in the drawings may be expressed exaggeratedly compared to the actual implementation of the invention, and a detailed description of a configuration that is judged to unnecessarily obscure the gist of the present invention is omitted or briefly described.

In addition, although various embodiments are described using terms used in some communication standards (e.g., 3GPP, open radio access network (O-RAN)) in the specification of the present invention, these are only examples for explanation. Various embodiments of the present invention can be easily modified and applied to other communication systems.

In addition, each of the embodiments described in the specification of the present invention may be applied to each of the 3rd generation (3G) mobile communication system, a long term evolution (LTE) mobile communication system, the LTE-Advanced (LTE-A) mobile communication system, the 4G mobile communication system, the 5G mobile communication system, the 6th generation (6G) mobile communication system, new radio (NR), as well as the next generation mobile communication system, and combined systems thereof.

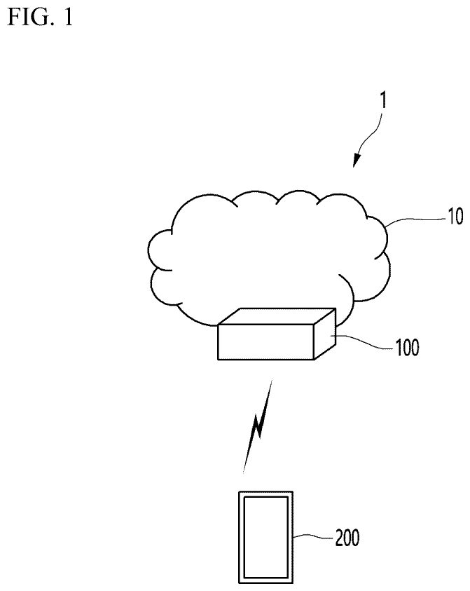

FIG. 1 is a diagram illustrating a schematic configuration of a wireless communication system 1 according to an embodiment of the present invention.

Referring to FIG. 1, the wireless communication system 1 may be a wireless communication system (e.g., NR) according to 3G, 4G, 5G or next generation (NG). The wireless communication system 1 may include a radio access network 10, and a base station 100 and user equipment (UE) 200 included in the radio access network 10. The radio access network 10 may be connected to a core network according to 3G, 4G, 5G or NG.

Meanwhile, the base station 100 may perform wireless communication with the UE 200. The base station 100 and the UE 200 may perform wireless communication with each other by controlling radio signals transmitted and received through antennas.

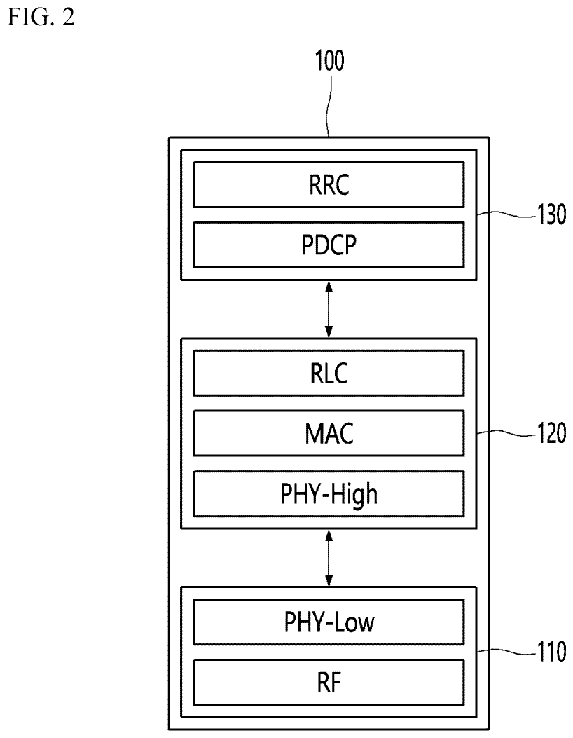

FIG. 2 is a diagram illustrating a base station 100 according to an embodiment of the present invention.

Referring to FIG. 2, a fronthaul interface specified by O-RAN may be applied to the base station 100. However, it is not limited thereto, and other standards or specifications may be applied.

The base station 100 may include a radio unit (O-RU, O-RAN Radio Unit, 110), a distributed unit (O-DU, O-RAN Distributed Unit, 120), and a central unit (O-CU, O-RAN Central Unit, 130). Each of the O-RU 110, the O-DU 120, and the O-CU 130 is functionally split (function split).

The O-RU 110 may perform functions related to a PHY-Low layer and radio frequency (RF) processing.

The O-DU 120 may perform functions related to a radio link control (RLC) layer, a medium access control (MAC) layer, and a PHY-High layer.

The O-CU 130 may perform functions related to radio resource control (RRC) and a packet data convergence protocol (PDCP) layer.

Meanwhile, when a fronthaul interface is applied to the O-RU 110 and the O-DU 120, communication may be performed in a control plane (C-plane), a user plane (U-plane), a synchronization plane (S-plane), and a management plane (M-plane).

The U-plane may include user's downlink data (IQ data, SSB/RS), uplink data (IQ data or SRS/RS), or PRACH data.

The C-plane may include a message for controlling the transmission and reception of the U-plane. The C-plane may be configured to provide scheduling information and beamforming information through a control message.

The S-plane may include a message for timing and synchronization control.

The M-plane may be related to a start-up procedure and may include a message required for managing the O-RU 110 and the O-DU 120.

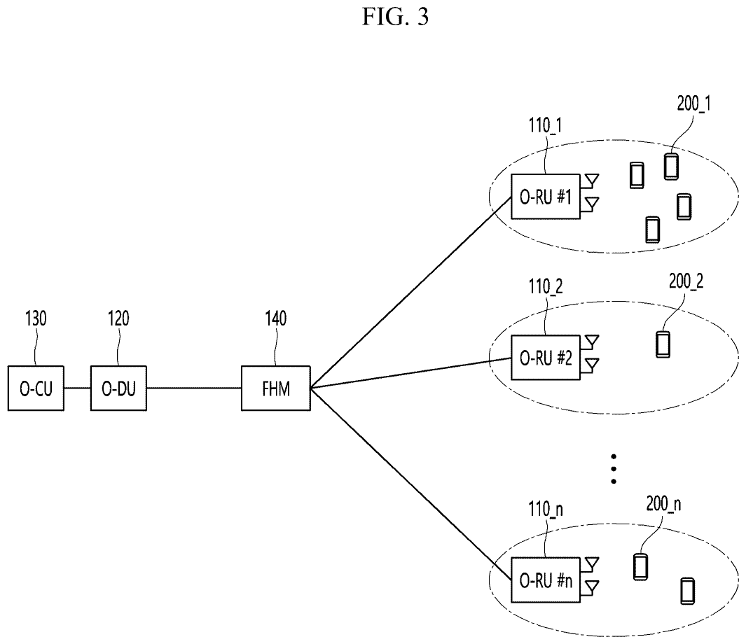

FIG. 3 is a diagram illustrating a network configuration including a fronthaul multiplexer (FHM) according to an embodiment of the present invention.

Referring to FIG. 3, a FHM 140 may be disposed between the O-DU 120 and the O-RU 110 to establish a network to which a shared cell is applied. That is, a distributed network structure using a shared cell function may be established as a method for expanding a service coverage. Meanwhile, the FHM 140 may be disposed as a separate device between the O-DU 120 and the O-RU 110, or may be integrated with the O-DU 120 and disposed as a single unit.

The FHM 140 may transmit a signal received from the O-DU 120 to each of a plurality of O-RUs 110_1, 110_2, . . . , and 110_n as n individual signals, or synthesize the n signals received from the plurality of O-RUs 110_1, 110_2, . . . , and 110_n and transmit the synthesized signals to the O-DU 120.

Meanwhile, each of the plurality of O-RUs 110_1, 110_2, . . . , and 110_n may transmit radio signals to a plurality of pieces of UE 200_1, 200_2, . . . , and 200_n connected within the service coverage.

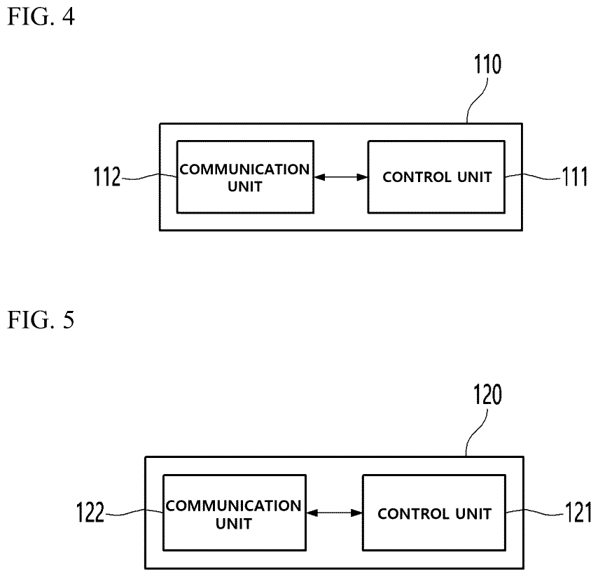

FIG. 4 is a block diagram illustrating a radio unit (O-RU) 110 according to an embodiment of the present invention.

Referring to FIG. 4, the O-RU 110 may include a communication unit 111 and a control unit 112. The communication unit 111 may perform communication with the O-DU 120 and the UE 200. In addition, the control unit 112 may process data received from the O-DU 120 and the UE 200.

FIG. 5 is a block diagram illustrating a distributed unit (O-DU) 120 according to an embodiment of the present invention.

Referring to FIG. 5, the O-DU 120 may include a communication unit 121 and a control unit 122. The communication unit 121 may perform communication with the O-RU 110, the O-CU 130, and the FHM 140. In addition, the control unit 122 may process data received from the O-RU 110, the O-CU 130, and the FHM 140.

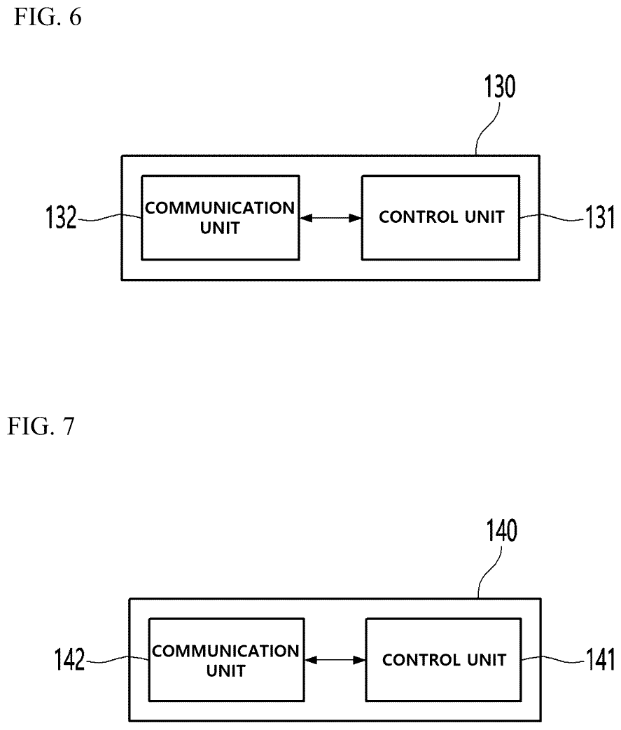

FIG. 6 is a block diagram illustrating a central unit (O-CU) 130 according to an embodiment of the present invention.

Referring to FIG. 6, the O-CU 130 may include a communication unit 131 and a control unit 132. The communication unit 131 may perform communication with the O-DU. In addition, the control unit 132 may process data received from the O-DU 120.

FIG. 7 is a block diagram illustrating a FHM 140 according to an embodiment of the present invention.

Referring to FIG. 7, the FHM 140 may include a communication unit 141 and a control unit 142. The communication unit 141 may perform communication with the O-DU 120 and the O-RU 110. In addition, the control unit 142 may process data received from the O-DU 120 and the O-RU 110.

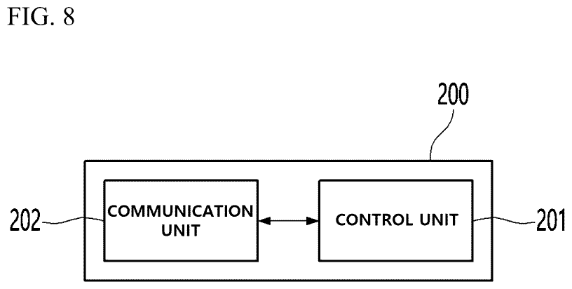

FIG. 8 is a block diagram illustrating user equipment (UE) 200 according to an embodiment of the present invention.

Referring to FIG. 8, the UE 200 may include a communication unit 201 and a control unit 202. The communication unit 201 may perform communication with the O-RU 110. In addition, the control unit 202 may process data received from the O-RU 110.

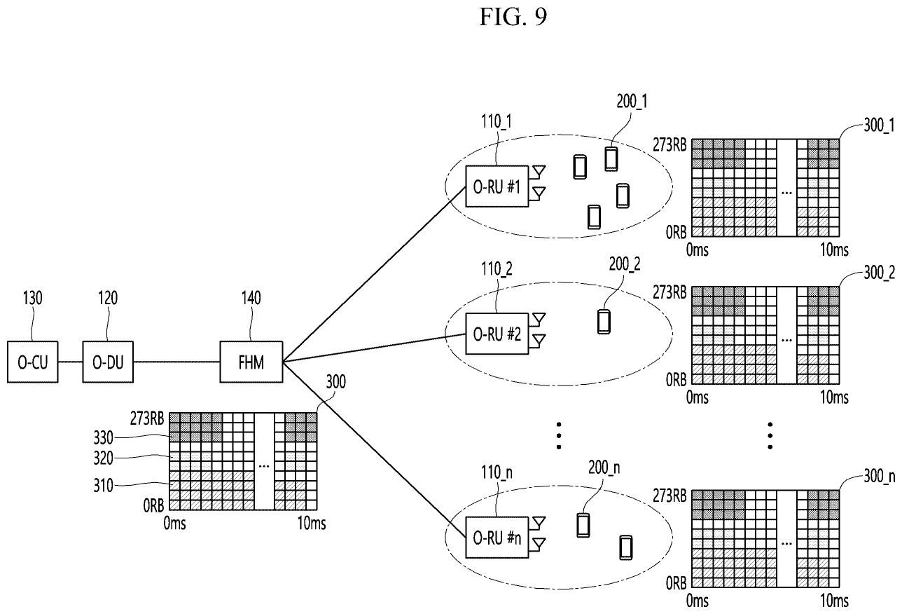

FIG. 9 is a diagram illustrating a method for processing a physical resource block in a conventional wireless communication system.

Referring to FIG. 9, in a conventional radio communication system, a physical resource block 300 allocated by scheduling between a UE 200 and a O-DU 120 may be transmitted equally to the plurality of O-RUs 110_1, 110_2, . . . , and 110_n by the FHM 140. The physical resource block 300 may include information on a first resource block area 310 allocated to a first O-RU 110_1, a second resource block area 320 allocated to a second O-RU 110_2, and a resource block area 330 allocated to an n-th O-RU 110_n. Each of the plurality of O-RUs 110_1, 110_2, . . . , and 110_n may transmit radio signals based on the physical resource blocks 300_1, 300_2, . . . , and 300_n received from the FHM 140.

In this case, the plurality of O-RUs 110_1, 110_2, . . . , and 110_n may transmit radio signal waves based on the physical resource block (PRB) of the entire base station cell regardless of the plurality of pieces of UE 200_1, 200_2, . . . , and 200_n within the service coverage, which causes a problem of using the maximum power.

For example, when using a bandwidth of 100 MHz in 5G, a maximum of 273 PRBs are used, and in a distributed network using a shared cell, a problem may occur in which all the O-RUs 110 use 273 PRBs.

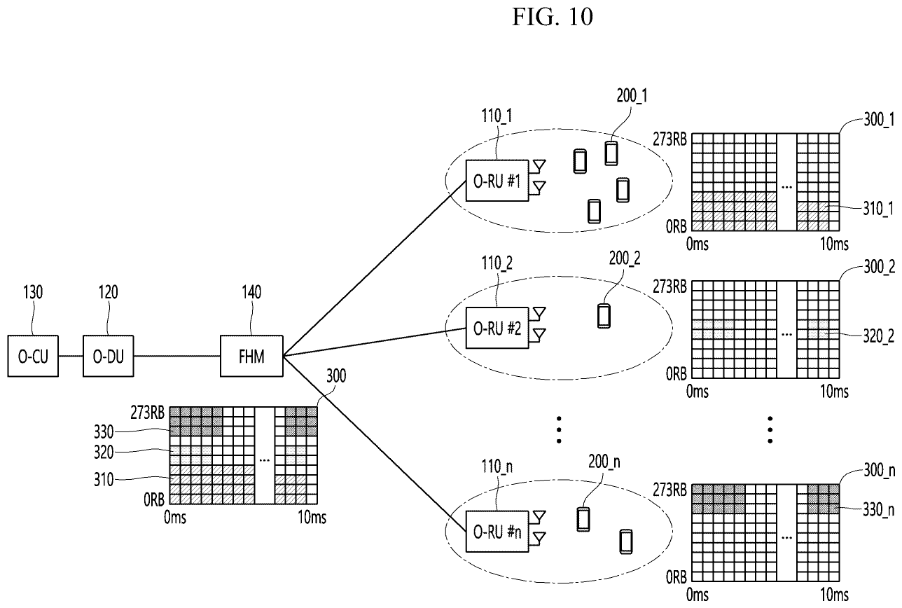

FIG. 10 is a diagram illustrating a method for processing a physical resource block in a wireless communication system according to an embodiment of the present invention.

Referring to FIG. 10, in a wireless communication system 1 of the present invention, for a physical resource block 300 allocated by scheduling between the UE 200 and the O-DU 120, the FHM 140 may distribute and transmit only the physical resource blocks allocated to each of the plurality of O-RUs 110_1, 110_2, . . . , and 110_n to each of the plurality of O-RUs 110_1, 110_2, . . . , and 110_n. In addition, the FHM 140 may transmit only packet data for the physical resource blocks allocated to each of the plurality of O-RUs 110_1, 110_2, . . . , and 110_n to each of the plurality of O-RUs 110_1, 110_2, . . . , and 110_n. The physical resource block 300 may include information on a first resource block area 310 allocated to the first RU 110_1, a second resource block area 320 allocated to the second O-RU 110_2, and a resource block area 330 allocated to the n-th O-RU 110_n. Each of the plurality of O-RUs 110_1, 110_2, . . . , and 110_n may transmit radio signals based on the physical resource blocks 300_1, 300_2, . . . , and 300_n distributed from the FHM 140.

In this case, the plurality of O-RUs 110_1, 110_2, . . . , and 110_n may transmit radio signal waves only for the plurality of pieces of UE 200_1, 200_2, . . . , and 200_n within the service coverage, thereby reducing the power consumption.

For example, when the power consumption of the O-RU 110 is 500 W and the number of the O-RUs 110 used in a network is 10, in the conventional method, the total power consumption is 500 W*10=5 kW. However, in the case of using a method of processing physical resource blocks according to one embodiment of the present invention, since the sum of resources used by all RUs (e.g., 10 RUs) is equal to the sum of resources used by one RU, the power consumption may be 500 W (excluding standby power).

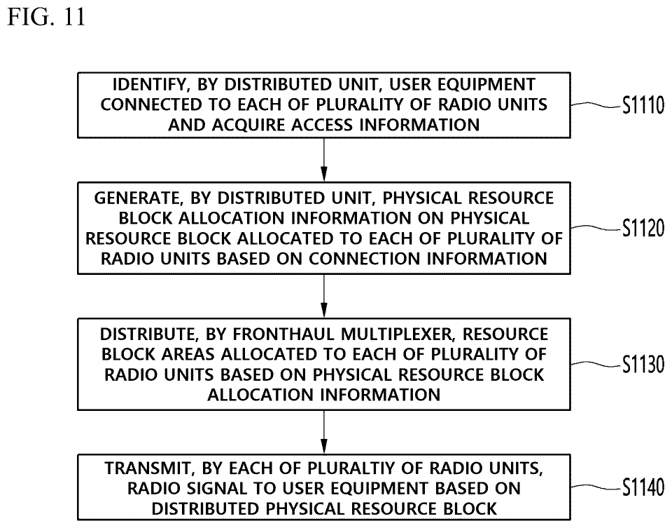

FIG. 11 is a flowchart illustrating a method for processing a physical resource block in a wireless communication system according to an embodiment of the present invention.

The O-DU 120 may acquire connection information by identifying the UE 200 connected to each of the plurality of O-RUs 110 in operation S1110. The connection information may mean information that can identify at least one piece of UE 200 connected to each of the plurality of RUs 110.

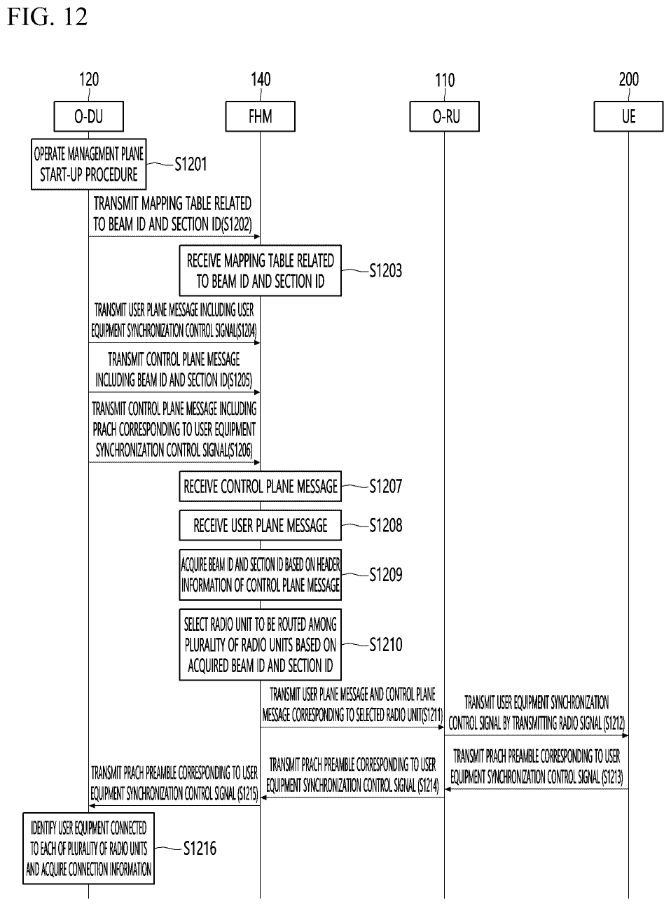

FIG. 12 is a flowchart illustrating a method for processing a physical resource block in a wireless communication system according to an embodiment of the present invention. Hereinafter, a method for the O-DU 120 to acquire connection information will be described with reference to FIG. 12.

The O-DU 120 may operate an M-plane start-up procedure in operation S1201.

The O-DU 120 may transmit a mapping table related to a beam ID (BeamID) and a section ID (SectionID) to the FHM 140 in operation S1202.

In addition, the FHM 140 may receive the mapping table from the O-DU 120 in operation S1203.

Meanwhile, the mapping table may include information that specifies which of the plurality of O-RUs 110 the FHM 140 will transmit control signals (e.g., SSB, CSI-RS) to during the process of the M-plane start-up procedure.

In addition, the O-DU 120 may transmit an extended antenna-carrier (eAxC) ID to the FHM 140.

Meanwhile, in operation S1204, the O-DU 120 may transmit, to the FHM 140, a user plane (U-plane) message including a UE synchronization control signal for determining which of the plurality of RUs 110 is connected to the UE 200.

The UE synchronization control signal may include a synchronization signal block or a CSI-RS.

In addition, the O-DU 120 may transmit a control plane (C-plane) message to the FHM 140 in operation S1205. The C-plane message may include a beam ID and a section ID.

In addition, the O-DU 120 may transmit the C-plane message including a PRACH corresponding to the UE synchronization control signal to the FHM 140 in operation S1206.

Meanwhile, the FHM 140 may receive the U-plane message and the C-plane message from the O-DU 120 in operations S1207 and S1208.

The FHM 140 may acquire the beam ID and the section ID based on header information of the received C-plane message in operation S1209.

In addition, the FHM 140 may select an O-RU to be routed among the plurality of O-RUs 110 based on the acquired beam ID and section ID in operation S1210.

For example, the FHM 140 may select an O-RU to which the U-plane message and the C-plane message are to be routed based on the acquired beam ID and section ID, and the mapping table.

Meanwhile, the FHM 140 may transmit the U-plane message and the C-plane message corresponding to the selected O-RU to the selected O-RU in operation S1211.

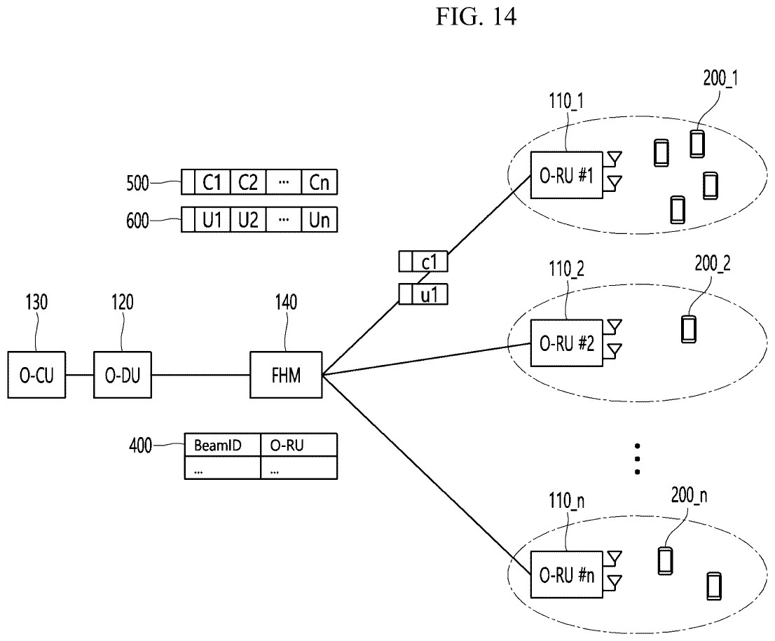

Meanwhile, FIG. 14 is a flowchart illustrating a method for selecting an O-RU to be routed according to an embodiment of the present invention.

Referring to FIG. 14, when the n-th O-RUs 110 are connected to the FHM 140, the mapping table 400 may include the following information.

TABLE 1

| beamID | O-RU |
|---|---|
| #1 | #1 |
| #2 | #2 |
| . . . | . . . |
| #n | #n |

Meanwhile, the values of the section ID and beam ID may be the same, and each of the n-th O-RUs 110 may communicate with one piece of UE 200.

In addition, the C-plane message 500 may include a plurality of C-plane messages C1 to Cn to be transmitted to each of the plurality of O-RUs 110, and section ID and beam ID information matching each of the C-plane messages C1 to Cn may be included in the header of the C-plane message.

In addition, a U-plane message 600 may include a plurality of U-plane messages U1 to Un to be transmitted to each of the plurality of O-RUs 110. Section ID information matching each of the U-plane messages U1 to Un may be included in the header of the U-Plane message.

For example, the FHM 140 may acquire a beam ID #1 and a section ID #1 of the C-plane message cl based on the header information of the received C-plane message, and may select a RU 110_1 to be routed among the plurality of O-RUs 110 using the acquired beam ID #1 and section ID #1, and the mapping table 400.

In addition, the FHM 140 may transmit packet data of the U-plane message ul matching the acquired section ID #1 to the O-RU 110_1.

Referring again to FIG. 12, the O-RU 110 selected by being routed by the FHM 140 may transmit a radio signal to transmit the UE synchronization control signal to at least one piece of UE 200 in operation S1212.

In addition, the O-RU 110 may receive a PRACH preamble corresponding to the UE synchronization control signal from the UE 200 in operation S1213.

In addition, the O-RU 110 may transmit the received PRACH preamble to the FHM 140 in operation S1214.

In addition, the FHM 140 may transmit the received PRACH preamble to the O-DU 120 in operation S1215.

Meanwhile, the O-DU 120 may identify the at least one piece of UE 200 connected to each of the plurality of O-RUs 110 based on the received PRACH preamble, and acquire connection information in operation S1216.

Referring again to FIG. 11, the description will be made.

The O-DU 120 may generate physical resource block allocation information on resource block areas allocated to each of the plurality of O-RUs based on the connection information in operation S1120.

For example, referring to FIG. 10, the O-DU 120 may generate resource block allocation information including allocation information indicating that the first resource block area 310 of the physical resource block 300 is allocated to the first O-RU 110_1, allocation information indicating that the second resource block area 320 is allocated to the second O-RU 110_2, and allocation information indicating that the resource block area 330 is allocated to the n-th O-RU 110_n. Each allocation information may include information on the matching section ID and beam ID.

That is, the O-DU 120 may generate the physical resource block allocation information by matching the section ID and beam ID for the resource block area used by each of the plurality of O-RUs 110_1, 110_2, . . . , and 110_n.

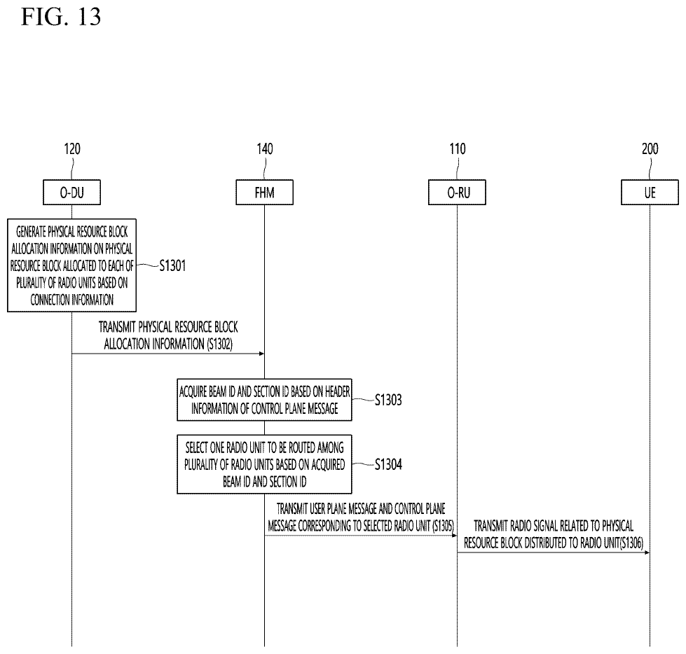

FIG. 13 is a flowchart illustrating a method for processing a physical resource block in a wireless communication system according to an embodiment of the present invention.

As described above, the O-DU 120 may generate the physical resource block allocation information on the resource block areas allocated to each of the plurality of RUs based on the connection information in operation S1301.

Meanwhile, the O-DU 120 may transmit the physical resource block allocation information to the FHM 140.

Meanwhile, the FHM 140 may acquire a beam ID and a section ID based on header information of a C-plane message received from the O-DU 120 in operation S1303.

In addition, the FHM 140 may select one O-RU to be routed among the plurality of RUs based on the acquired beam ID and section ID in operation S1304.

In addition, the FHM 140 may transmit a U-plane message and a C-plane message corresponding to the selected RU to the O-RU 110 in operation S1305.

In addition, the FHM 140 may distribute the resource block areas allocated to each of the plurality of RUs based on the physical resource block allocation information.

For example, referring to FIG. 10, the FHM 140 may specify the O-RUs 110_1, 110_2, . . . , and 110_n to which each of the resource block areas 310, 320, and 330 is allocated based on the acquired beam ID and section ID. The FHM 140 may distribute the plurality of physical resource blocks 300_1, 300_2, . . . , and 300_n that include only the resource block areas 310_1, 320_2, . . . , and 330_n allocated to each of the plurality of O-RUs 110_1, 110_2, . . . , and 110_n, to each of the plurality of O-RUs 110_1, 110_2, . . . , and 110_n.

In addition, the FHM 140 may transmit the U-plane message including information on the resource block areas 310_1, 320_2, . . . , and 330_n allocated to each of the plurality of O-RUs 110_1, 110_2, . . . , and 110_n, to each of the plurality of O-RUs 110_1, 110_2, . . . , and 110_n.

Meanwhile, each of the plurality of O-RUs 110 may transmit a radio signal to the at least one piece of UE 200 based on the distributed physical resource blocks in operation S1306.

In the present specification, each block may represent a module, segment, or portion of code that includes one or more executable instructions for implementing the specified logical function(s). It should also be noted that in some alternative implementations, the functions noted in the blocks may occur out of the order shown. For example, two blocks shown in succession may in fact be executed substantially concurrently or the blocks or steps may sometimes be executed in the reverse order, depending upon the functionality involved.

Although the embodiments of the present invention have been described in more detail with reference to the attached drawings, the present invention is not necessarily limited to these embodiments, and various modifications may be made within the scope that does not depart from the technical idea of the present invention. Therefore, the embodiments disclosed in the present invention are not intended to limit the technical idea of the present invention but to describe the present invention, and the scope of the technical idea of the present invention is not limited by these embodiments. Therefore, the above-described embodiments should be understood as illustrative, instead of limiting, in all aspects. The protection scope of the present invention should be interpreted by the following claims, and all technical ideas within the equivalent scope should be interpreted as being included in the scope of the present invention.

1. A method for processing a physical resource block in a wireless communication system, the method comprising:
identifying, by a distributed unit, user equipment (UE) connected to each of a plurality of radio units (RUs) and acquiring connection information;
generating, by the distributed unit, physical resource block allocation information on a resource block area allocated to each of the plurality of RUs based on the connection information;
distributing, by a fronthaul multiplexer (FHM), the resource block area allocated to each of the plurality of RUs based on the physical resource block allocation information; and
transmitting, by each of the plurality of RUs, a radio signal to at least one piece of UE based on the distributed physical resource block.

2. The method of claim 1, wherein the acquiring of the connection information includes transmitting, by the distributed unit, a mapping table related to a beam ID and a section ID to the FHM by performing a management plane (M-plane) start-up procedure.

3. The method of claim 1, wherein the acquiring of the connection information includes:
transmitting, by the distributed unit, a user plane (U-plane) message including a UE synchronization control signal to the FHM; and
transmitting, by the distributed unit, a control plane message including a beam ID and a section ID to the FHM.

4. The method of claim 3, wherein the UE synchronization control signal includes a synchronization signal block or a channel state information-reference signal (CSI-RS).

5. The method of claim 3, wherein the control plane message includes a physical random access channel (PRACH) corresponding to the UE synchronization control signal.

6. The method of claim 5, wherein the acquiring of the connection information includes:
acquiring, by the FHM, the beam ID and the section ID based on header information of the received control plane message;
selecting, by the FHM, a RU to be routed among the plurality of RUs based on the acquired beam ID and section ID; and
transmitting, by the FHM, the user plane message and the control plane message corresponding to the selected RU to the selected RU.

7. The method of claim 6, wherein the acquiring of the connection information includes:
transmitting, by the selected RU, the UE synchronization control signal to at least one piece of UE;
receiving, by the selected RU, a PRACH preamble corresponding to the UE synchronization control signal from the UE;
transmitting, by the selected RU, the received PRACH preamble to the FHM; and
transmitting, by the FHM, the received PRACH preamble to the distributed unit.

8. The method of claim 1, wherein the generating of the physical resource block allocation information includes generating the physical resource block allocation information by matching a section ID and a beam ID for a resource block area used by each of the plurality of RUs.

9. The method of claim 8, wherein the distributing of the physical resource block includes:
selecting, by the FHM, one RU to be routed from the plurality of RUs based on the beam ID and the section ID; and
transmitting, by the FHM, a user plane message and a control plane message corresponding to the selected RU to the selected RU.

10. The method of claim 9, wherein the transmitting of the radio signal includes transmitting the radio signal for the physical resource block allocated to the selected RU.
